(19) United States
(12) Patent Application Publication
(10) Pub. No.: US 2012/0269940 A1
(43) Pub. Date: Oct. 25, 2012

(54) SYSTEM AND PROCESS FOR PRODUCING AGGLOMERATED POTATO PRODUCT

(75) Inventors: Michael L. Hamann, Caldwell, ID (US); David N. Gallina, Nampa, ID (US); Stephen L. O'Bannon, Caldwell, ID (US); Bruce T. Pittard, Caldwell, ID (US); Terry L. Zesiger, Parma, ID (US)

(73) Assignee: J.R. SIMPLOT COMPANY, Boise, ID (US)

(21) Appl. No.: 13/453,122

(22) Filed: Apr. 23, 2012

Related U.S. Application Data
(60) Provisional application No. 61/478,817, filed on Apr. 25, 2011.

(51) Int. Cl. A23L 1/216; A23P 1/02

(52) U.S. Cl. 426/285; 99/483

(57) ABSTRACT

A system and process for producing an agglomerated potato product from dried flakes and/or granules, and pre-blended dry and wet ingredients. The system and process include pre-blending of dry and wet ingredients such as salt, powdered milk, butter flavors, with warm water and/or oil, followed by mixing with dry potato flakes or the like to produce an agglomerated potato product having a crumbly consistency. This product is delivered by an auger to a conveyor for passage beneath a rotary driven roller for converting the product into a thin layer of small agglomerate type particles which are then delivered to a fluidized bed dryer for reducing the moisture content of the agglomerated potato product to about 6-8%. The resultant dried, agglomerated potato product has a generally granular consistency and is suitable for long-term storage preparatory to finish preparation by water addition to provide a flavorful potato product.

### BACKGROUND OF THE INVENTION

This invention relates generally to an improved system and process for producing an agglomerated potato product from dried potato flakes and/or potato granules. More particularly, the system and process relates to improvements in thorough mixing of wet and dry ingredients with the dried potato flakes and/or granules to produce an agglomerated potato product which can then be dried to a substantially granular or particulate state suitable for long-term storage preparatory to finish preparation by suitable addition of warm water.

### SUMMARY OF THE INVENTION

In accordance with the invention, a system and process are provided for producing an agglomerated potato product from relatively dry potato flakes and/or granules and pre-blended wet and dry ingredients. The potato flakes or the like are thoroughly mixed with the pre-blended wet and dry ingredients, and then delivered onto a conveyor for close passage beneath a rotatably driven roller to convert the mixed or agglomerated and now-granular or particulate product into a thin layer of relatively small agglomerate type particulates. This thin layer of small particulates is delivered by the conveyor to the input end of a dryer, which reduces the overall moisture content of the agglomerated product to a relatively low level, such as about 6-8% by weight, suitable for long-term storage.

The system and process comprise pre-blending of wet and dry ingredients such as ingredients including, e.g., salt, milk powders, butter flavors, and the like with water (and preferably warm water) and/or oil in selected proportions within a pre-blender or pre-mixer device. In a preferred form, warm water at a temperature of about 140° F. is added in selected proportion with the dry ingredients into the pre-blender device. Oil, such as a soy oil, is then added in selected proportion to the water and dry ingredients. One preferred pre-blender device comprises a blender produced by Lanco Products Corporation, New York, N.Y., under the model designation Likwifier LDD. This pre-blender is operated at a selected time and speed setting for thoroughly pre-blending or pre-mixing the wet and dry ingredients.

In a mixing device, preferably such as a mixer produced by Hobart Corporation of Troy, Ohio, under the model number 80, relatively dry potato flakes or the like, such as those obtained from a flake production line, wherein the potato flakes or the like are dried in that production line to a moisture content of about 6-8% by weight, are added together with addition of the pre-blended wet and dry ingredients. These flakes and the pre-blended wet and dry ingredients are mixed gently and for a relatively short time period in the mixing device to form the flake-based (and/or granule-based) agglomerated product, and then transferred as by an auger onto a conveyor having a moving conveyor belt.

The conveyor belt of the conveyor passes beneath a closely spaced and rotatably driven roller which converts the augered agglomerated product into the form of a relatively thin layer of small agglomerate type particles on the conveyor belt. In one preferred form, the conveyor belt moves at about 0.5 feet per second, whereas the roller comprises a roller element that is rotatably driven in the same direction as roller belt movement, but at a much higher rate of speed. For example, in the preferred form, the roller element is about 1.5 inches in diameter, and is rotatably driven at about 1,000-1,100 revolutions per minute (rpm). Such rotary speed converts to about 7.0 feet per second, or about 14-15 times the speed of the conveyor belt. This roller is positioned above the moving conveyor belt by a distance of about 3/32 inch.

The thus-produced thin layer of the agglomerated product has a generally particle-like or granular constituency. This thin layer of agglomerated product is supplied into a dryer, such as fluidized bed dryer of the type produced by Idaho Steel Products, Idaho Falls, Id. This dryer reduces the overall moisture content of the agglomerated product to about 6-8% in a particle-like or granular form suitable for long-term storage. The dried agglomerated product can be reconstituted when desired by mixture with water to produce a flavorful mashed potato-like comestible.

Other features and advantages of the invention will become more apparent from the following detailed description, taken in conjunction with the accompanying drawings which illustrate, by way of example, the principles of the invention.

### BRIEF DESCRIPTION OF THE DRAWINGS

The accompanying drawings illustrate the invention. In such drawings:

FIG. 1 is a flow chart depicting system and process steps of the present invention;

FIG. 2 is a fragmented perspective view illustrating addition of water to a pre-blender device;

FIG. 3 is a fragmented perspective similar to FIG. 2, but showing addition of dry ingredients to the pre-blender device;

FIG. 4 is a fragmented perspective similar to FIGS. 2 and 3, but showing addition of oil to the pre-blender device;

FIG. 5 is an enlarged fragmented perspective view showing the interior of the pre-blender device and illustrating a rotary mixing blade therein;

FIG. 6 is a fragmented perspective view similar to FIG. 5, but depicting mixing of the dry and wet ingredients within the pre-blender device;

FIG. 7 is a fragmented perspective illustrating removal of the mixed dry and wet ingredients from the pre-blender device;

FIG. 8 is another fragmented perspective view showing delivery of a selected quantity by weight of dry potato flakes;

FIG. 9 is an enlarged and fragmented perspective view showing a mixing device with the dry potato flakes therein, and further illustrating addition of the pre-blended dry and wet ingredients from the pre-blender device thereto;

FIG. 10 is another enlarged and fragmented perspective view showing the mixing device for preparing the intermixed or agglomerated flake-based potato product;

FIG. 11 is an enlarged and fragmented perspective view similar to FIG. 10, but depicting a watch or clock indicating elapsed mixing time;

FIG. 12 is a fragmented perspective view showing scooped removal of the agglomerated flake-based product and placement thereof into an auger hopper;

FIG. 13 is a fragmented perspective view depicting auger delivery of the agglomerated flake-based product onto a conveyor having a moving conveyor belt;

FIG. 14 is an enlarged and fragmented perspective view of the conveyor, and illustrating a roller for converting the product into a thin layer of relatively small agglomerate type particulates on the moving conveyor belt;

FIG. 15 is a fragmented perspective view showing a downstream end of the conveyor delivering the agglomerated flake-based product into an entrance chute of a fluidized bed dryer;

FIG. 16 is a perspective view showing an upstream or inlet entrance end of the fluidized bed dryer; and

FIG. 17 is a perspective view depicting a downstream or exit end of the fluidized bed dryer.

### DETAILED DESCRIPTION OF THE PREFERRED EMBODIMENTS

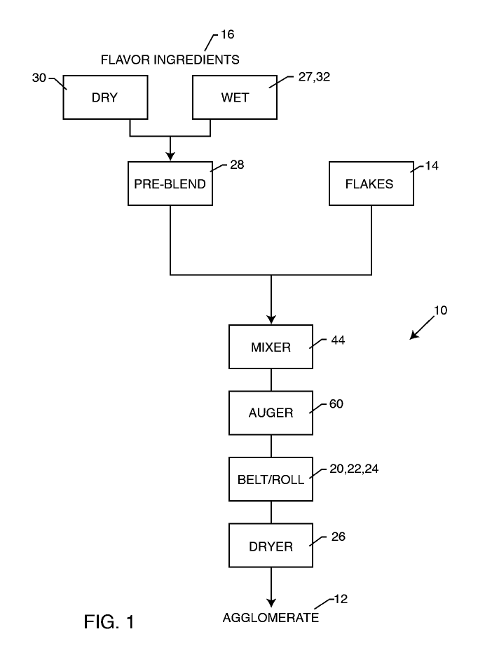

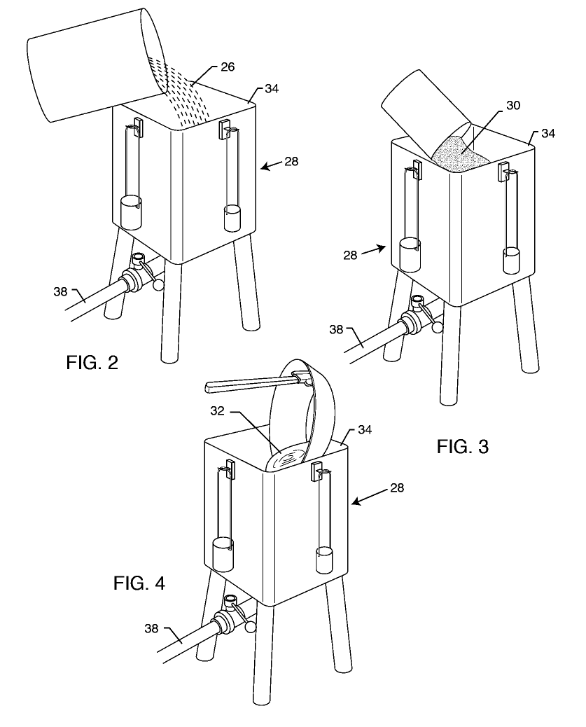

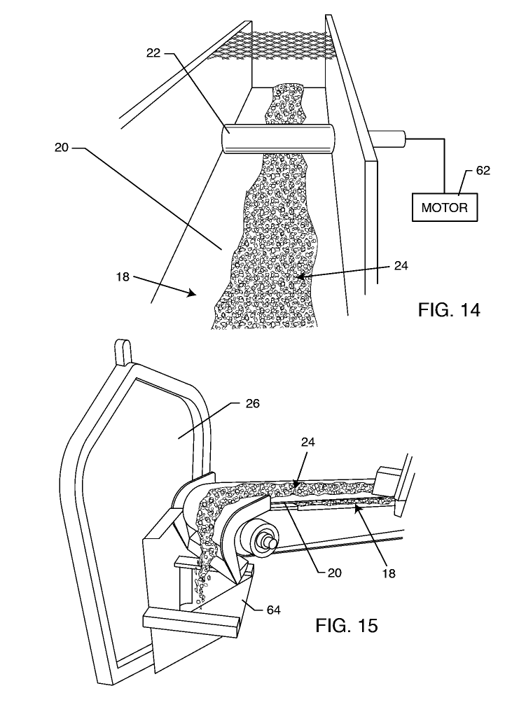

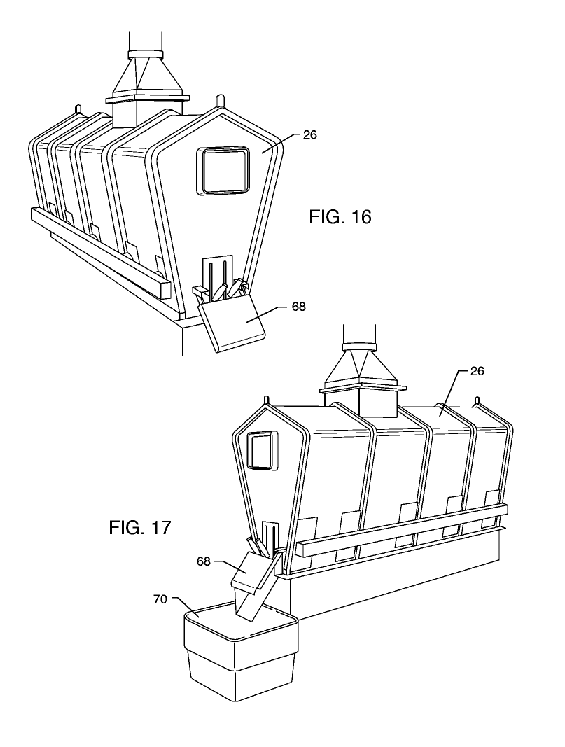

As shown in the exemplary drawings, an improved system and process referred to generally in FIG. 1 by the reference numeral 10 is provided for producing an agglomerated potato product 12 from potato flakes 14 and/or granules or the like, and mixtures thereof. The invention generally comprises pre-blending wet and dry ingredients 16 (FIGS. 2-7) before mixing them with the potato flakes 14 (FIGS. 8-11), followed by a conveyor 18 (FIGS. 13-15) having a moving belt 20 in combination with a rotatably driven roller 22 (FIG. 14) mounted over the belt 20 in closely spaced relation and driven at a speed significantly greater than the belt speed. As a result, the agglomerated or mixed flakes 14 and wet/dry ingredients 16 are converted to a thin layer 24 (FIGS. 14-15) of small agglomerate type particulates before being delivered to a final dryer 26 (FIGS. 15-17) wherein the agglomerated product 12 is dried to a relatively low moisture content.

In general terms, the final or finished dried agglomerated potato product 12 of the present invention has a particle-like or granular geometry that is not pasty or sticky at any point in the process. The dried agglomerated potato product 12, or agglomerate 12, is thus conducive to long-term storage to await finish preparation by placement thereof into a selected quantity of warm or heated water for reconstitution. The resultant finish prepared potato product exhibits a desirably high degree of product uniformity including texture and flavor. Although described and shown in terms of a preferred embodiment using potato flakes 14, persons skilled in the art will recognized that other types of dried potato products, such as potato granules and the like, and/or mixtures thereof, can be used in lieu of potato flakes 14.

As illustrated best in FIG. 2, the wet ingredients particularly such as water 27 is placed or poured into a pre-blender 28 in a selected quantity, according to the particular formulation of the wet and dry ingredients 16. In a preferred batch-type process, about 22 pounds of water 27 heated to a moderate or warm temperature within the range of about 125° to about 160° F., and more preferably about 140° F., for mixture with about 25 pounds of potato flakes 14 (as will be described herein in more detail). Persons skilled in the art will recognize and appreciate that the specific quantity or weight of water 27 added to the pre-blender 28 can vary according to the particular formulation of the ingredients 16 as well as the size of batch of the agglomerated potato product 12 to be produced. Persons skilled in the art will also understand that alternative water temperatures, such as tap water at a relatively moderate temperature as low as about 40° F., or a tepid temperature, can be used.

FIG. 3 shows addition to the pre-blender 28 of dry ingredients 30. In one preferred form, the dry ingredients 30 comprise ingredients such as about 130 grams of flavor and texture enhancers such as buttermilk powder, lactic acid, and sodium stearoyl lactylate, and/or mixtures thereof, and coloring agents such as annatto (about 0.25 grams) and tumeric (about 0.125 grams). Again, persons skilled in the art will understand that the specific ingredient mixture can vary by ingredient type and/or the end result desired, and/or the amount of agglomerated potato product 12 to be produced.

FIG. 4 shows addition to the previously added water 27 (FIG. 2) and the dry ingredients 30 (FIG. 3) of an oil or oil mixture 32 into the pre-blender 28. In this regard, in a preferred form, this oil mixture 32 comprises a soy oil (about 0.5 pounds).

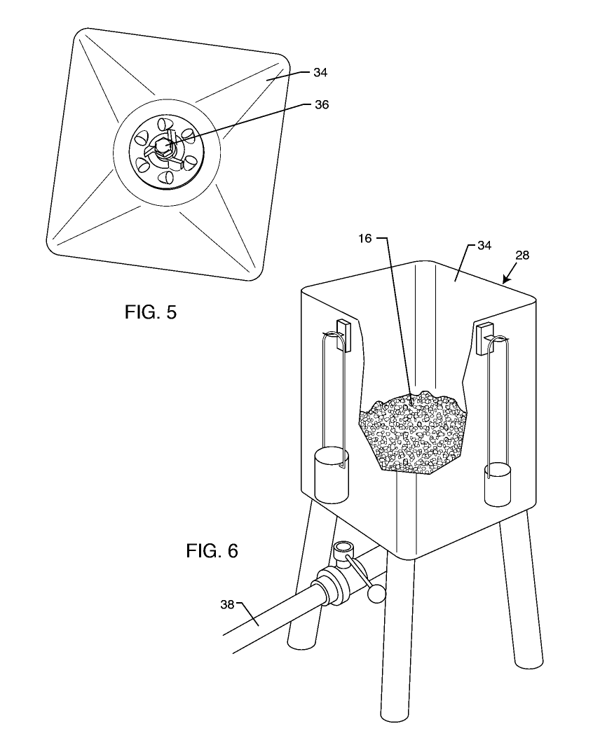

The pre-blender 28, in the preferred form of the invention, comprises a model Likwifier LDD marketed by Lanco Products Corporation, New York, N.Y. As shown in FIG. 5, this pre-blender 28 has a stainless steel receptacle 34 having a small blender-like multi-rotor blade 36 upstanding a short distance into a central bottom region thereof. This blade 36 is rotatably driven by an electric motor (not shown) or the like at a relatively high rate of speed (about 1,780 rpm in a preferred embodiment), and for a time period of about 3 minutes. Persons skilled in the art will appreciate, however, that the mixing blade 36 can be rotatably driven at a different (higher or lower) speed and for a different time period (shorter or longer) sufficient to thoroughly pre-mix the wet and dry ingredients 16.

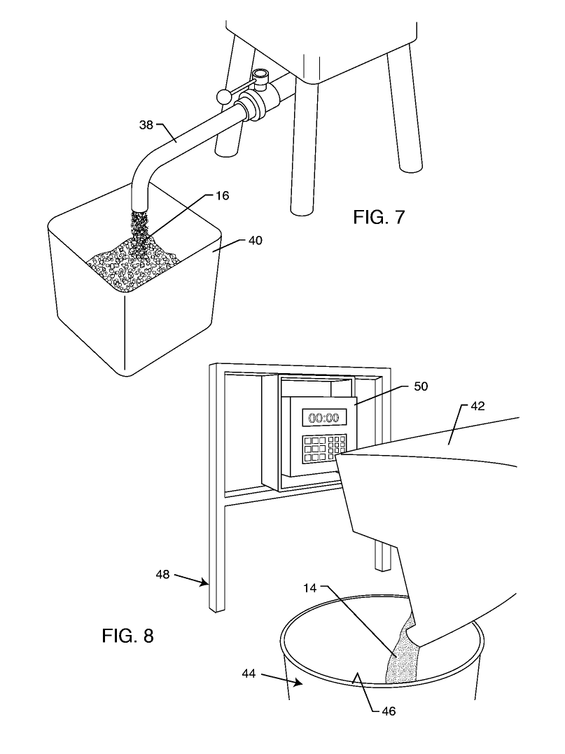

FIG. 6 illustrates the wet and dry ingredients 16 within the receptacle 34 of the pre-blender 28 during mixing or blending, i.e., during rotation of the mixing blade 36 (FIG. 5). FIG. 7 depicts tapping off of the pre-blended wet and dry ingredients 16 via a tap pipe 38 into a suitable container 40.

FIG. 8 shows pouring of a predetermined quantity of a selected processed and dried potato product, such as the illustrative potato flakes 14, from a bag 42 into a primary mixer 44 including an upwardly open mixing bowl 46. The bowl 46 is shown on a scale 48 with a digital or similar display 50 for providing a read-out of the weight of the potato flakes 14 added thereinto. In a preferred form, as previously mentioned, 25 pounds of the potato flakes 14 are poured into the mixing bowl 46. Persons skilled in the art will recognize and appreciate, of course, that the specific quantity or weight of flakes 14 poured into the mixing bowl 46 will vary according to the quantity of agglomerated product 12 to be produced. Persons skilled in the art will also appreciate that the flakes 14 can be obtained from a dryer (not shown) or the like at the conclusion of a known flake-making process, and/or that alternative processed and dried potato products such as granules can be used.

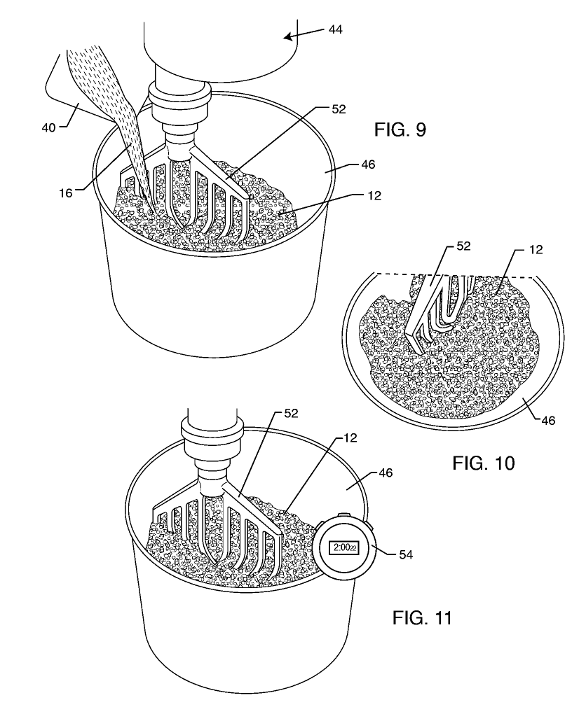

FIG. 9 depicts pour-in addition of the pre-blended wet and dry ingredients 16 from the container 40 into the mixing bowl 46 of the mixer 44, while stirring or mixing the constituents by means of rotation of a mixing blade 52. These wet and dry ingredients 16 are added into the mixer 44 for contact with and gentle mixing with the flakes 14 over a relatively short period of time, about 60 seconds in the preferred process, to raise the moisture level of the mixed or agglomerated product 12 to about 30% to about 55% by weight. Further product mixing or agglomeration is shown in FIG. 9, whereas FIG. 11 depicts further agglomeration with a stopwatch 54 indicating a total mixing time of about 2 minutes. One preferred mixer 44 comprises a model 80 mixer available from Hobart Corporation, Troy, Ohio, with the illustrated mixing blade 52 being rotatably driven at about 55-75 rpm, and more preferably about 65 rpm. Again, persons skilled in the art will understand that these parameters can vary in accordance with the quantity or weight of the agglomerated product 12 to be produced in each batch.

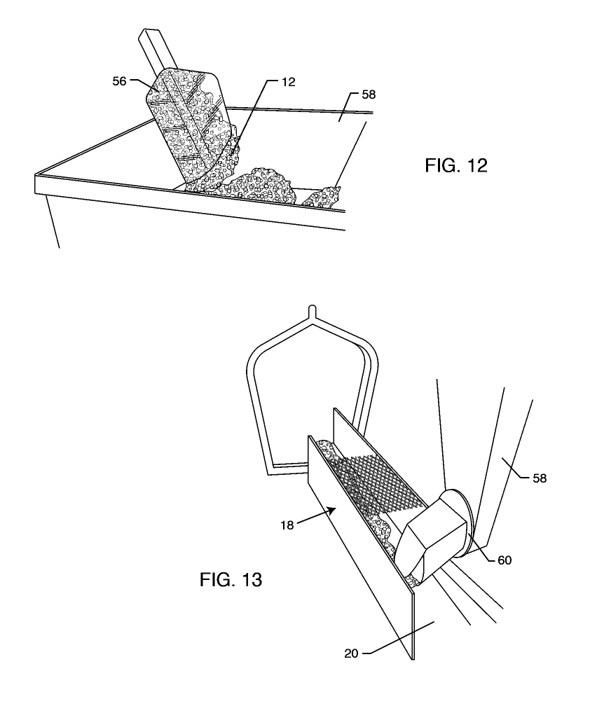

FIG. 12 shows the agglomerated product 12 from the mixer 44 being delivered by means of a manual scoop 56 or the like into an auger hopper 58. An auger 60 (FIG. 13) at a lower end of the hopper 58 feeds the agglomerated product 12 substantially continuously from the hopper 58 onto the moving belt 20 of the conveyor 18. The auger 60 beneficially smooths out the delivery of the agglomerated product 12 onto the conveyor 18, but it is noted that the agglomerated product 12 includes the wet components of the ingredients 16 and thus transfers onto the belt 20 in the form of small clumps. However, despite the presence of the wet ingredients, the agglomerated product 12 has a generally particulate form that is sufficiently crumbly for relatively easy breaking apart upon auger feeding onto the conveyor belt 20 and subsequent handling.

Downstream from the auger 60, in accordance with the movement direction of the belt 20, the roller 22 (FIG. 14) is disposed in slight spaced and generally parallel relation over the belt 20. In a preferred form, the roller 22 is spaced above the belt 20 by a short distance or gap on the order of about 3/32 inch. The roller 22 is rotatably driven by an electric motor 62 (shown schematically in FIG. 14) to rotate at a speed significantly greater than the moving speed of the conveyor belt 20. In particular, in the preferred form of the invention, the belt is driven or translated linearly at a speed of about 0.5 feet per second. The roller 22 comprises a removable and cleanable component having a plastic outer surface or the like of about 1.5 inch diameter disposed over the moving belt 20 by a short gap of about 3/32 inch. The motor 62 rotatably drives the roller 22 at a rotational speed directionally common with the direction of belt driving, but at a speed within the range of about 1,000-1,100 rpm, and more preferably on the order of about 1,050 rpm. This relatively high rate of roller rotational speed translates, given the roller diameter of about 1.5 inches, to a speed of about 7.0 feet per second, or about 14-15 times the speed of the belt 20.

In use, this arrangement between the belt 20 and the closely overlying roller 22 effectively spreads or flattens or thins the crumbly agglomerated product 12 into the relatively thin layer 24 of relatively small agglomerate type particles. In this regard, the illustrative drawings show the agglomerated product 12 as having a particle-like or substantially granular post-mixer construction suitable for fracturing easily into relatively uniform size small particles upon passage beneath the roller 22. This thin sheet 24 of the agglomerated product 12 is particularly suitable for entry into and through an entrance chute 64 (FIG. 15) of the dryer 26 (FIGS. 15-17), such as a conventional fluidized bed dryer of the type available from Idaho Steel Products, Idaho Falls, Id. In the dryer, the agglomerated product is substantially continuously dried to a moisture content of about 6-8% by weight. Such relatively low moisture for the agglomerated product 12 is achieved, in the preferred form, by an internal dryer temperature of from about 110° F. to about 285° F., and more preferably within a narrower range of from about 140° F. to about 180° F., and with a dryer air flow rate of about 1,250-1750 cubic feet per minute (cfm), and more preferably about 1,500 cfm, for a time period of between about 10-40 minutes. The illustrative dryer 26 has three air inlet zones pressurized to about +3 inches of water beneath an internal bubble plate (not shown), with the pressure above the bubble plate being about −0.5 inches of water. With these parameters, dried agglomerated potato product 12 is produced with substantially thorough mixing between the potato and pre-blended wet/dry constituents, at a rate in the preferred and above-discussed batch process of about 30 pounds per hour, and is discharged from the dryer 26 via an exit chute 68 of the dryer 26 (FIGS. 16-17) into a suitable receiver 70 (FIG. 17) for further product processing, such as packaging and the like.

A variety of further modifications and improvements in and to the improved system and process for producing a flake-based potato product of the present invention will be apparent to those persons skilled in the art. By way of specific example, persons skilled in the art will recognize and appreciate that the batch process shown and described herein can be converted to a flow-through continuous production process, if desired. Accordingly, no limitation on the invention is intended by way of the foregoing description and accompanying drawings, except as set forth in the appended claims.

What is claimed is:

1. A process for preparing an agglomerated potato product, said process comprising the steps of:
pre-blending dry and wet flavor ingredients in a pre-blender;
mixing the pre-blended dry and wet flavor ingredients with potato product dried to a moisture level of about 6-8% in a mixer to form the agglomerated potato product; and
delivering the relatively agglomerated potato product from the conveyor into a dryer for reducing the moisture level thereof to about 6-8% to produce the agglomerated potato product in substantially granular form.

2. The process of claim 1 wherein the dry and wet flavor ingredients include salt, powdered milk, butter flavors, lactic acid, sodium stearoyl lactylate, a coloring agent, water, or oil, or mixtures thereof.

3. The process of claim 2 wherein water comprises at least one of the wet flavor ingredients, said water being at a temperature of about 40° F. to about 160° F.

4. The process of claim 2 wherein water comprises at least one of the wet flavor ingredients, said water being at a temperature of about 140° F.

5. The process of claim 2 wherein oil comprises at least one of the wet flavor ingredients, said oil comprising a soy oil.

6. The process of claim 1 wherein the dried potato product includes potato flakes, or potato granules, or mixtures thereof.

7. The process of claim 1 further comprising the step of delivering the agglomerated potato product from the mixer onto a conveyor including the step of augering the agglomerated potato product onto the conveyor.

8. The process of claim 1 further including the step of passing the agglomerated potato product on the conveyor beneath a closely spaced overhead roller driven at a speed greater than the conveyor speed to form the mixed product into a relatively thin agglomerated product layer.

9. The process of claim 8 wherein the conveyor moves the agglomerated potato product at about 0.5 feet per second, and the roller has a diametric size of about 1.5 inch and is driven in the same direction at a rotational speed of about 1,000-1,100 revolutions per minute.

10. The process of claim 8 wherein the roller is spaced above the conveyor by about 3/32 inch.

11. The process of claim 1 wherein the dryer comprises a fluidized bed dryer with an air temperature within the range of from about 110° F. to about 285° F.

12. The process of claim 11 wherein the fluidized bed dryer has an air temperature within the range of from about 140° F. to about 180° F.

13. A process for preparing an agglomerated potato product, said process comprising the steps of:
pre-blending dry and wet flavor ingredients in a pre-blender, said dry and wet ingredients including salt, powdered milk, butter flavors, lactic acid, sodium stearoyl lactylate, a coloring agent, water, or oil, or mixtures thereof;
mixing the pre-blended dry and wet flavor ingredients with potato product including potato flakes or potato granules, or mixtures thereof, dried to a moisture level of about 6-8% in a mixer to form a mixed product;
delivering the mixed product from the mixer onto a conveyor;
passing the mixed product on the conveyor beneath a closely spaced overhead roller driven in a direction common to the conveyor but at a speed substantially greater than the conveyor speed to form the mixed product into a relatively thin mixed product layer; and
delivering the relatively thin mixed product layer from the conveyor into a dryer for reducing the moisture level thereof to about 6-8% to produce the agglomerated potato product in substantially granular form.

14. The process of claim 13 wherein water comprises at least one of the wet flavor ingredients, said water being at a temperature of about 40° F. to about 160° F.

15. The process of claim 14 wherein the water has a temperature of about 140° F.

16. The process of claim 13 wherein oil comprises at least one of the wet flavor ingredients, said oil comprising a soy oil.

17. The process of claim 13 wherein said step of delivering the mixed product from the mixer onto the conveyor includes the step of augering the mixed product.

18. The process of claim 13 wherein the conveyor moves the mixed product at about 0.5 feet per second, and the roller has a diametric size of about 1.5 inch and is driven in the same direction at a rotational speed of about 1,000-1,100 revolutions per minute.

19. The process of claim 18 wherein the roller is spaced above the conveyor by about 3/32 inch.

20. The process of claim 13 wherein the dryer comprises a fluidized bed dryer with an air temperature within the range of from about 110° F. to about 285° F.

21. The process of claim 20 wherein the fluidized bed dryer has an air temperature within the range of from about 140° F. to about 180° F.

22. A system for preparing an agglomerated potato product, said system comprising:
a pre-blender for pre-blending dry and wet flavor ingredients;
a mixer for mixing the pre-blended dry and wet flavor ingredients with potato product dried to a moisture level of about 6-8% to form the agglomerated potato; and
a dryer for receiving the agglomerated potato product and for reducing the moisture level thereof to about 6-8% to produce the agglomerated potato product in substantially granular form.

23. The system of claim 22 wherein the dry and wet flavor ingredients include salt, powdered milk, butter flavors, lactic acid, sodium stearoyl lactylate, a coloring agent, water, or oil, or mixtures thereof.

24. The system of claim 22 wherein water comprises at least one of the wet flavor ingredients, said water being at a temperature of about 40° F. to about 160° F.

25. The system of claim 22 wherein water comprises at least one of the wet flavor ingredients, said water being at a temperature of about 140° F.

26. The system of claim 22 wherein oil comprises at least one of the wet flavor ingredients, said oil comprising a soy oil.

27. The system of claim 22 wherein the dried potato product includes potato flakes or potato granules, or mixtures thereof.

28. The system of claim 18 further comprising an auger for delivering the agglomerated potato product onto a conveyor for conveying the agglomerated potato product to said dryer.

29. The system of claim 28 wherein the conveyor moves the agglomerated potato product in a first direction, and further comprising a roller spaced closely overhead relative to the conveyor, said roller being driven at a speed greater than the conveyor speed to form the mixed product into a relatively thin agglomerated potato product layer on the conveyor.

30. The system of claim 29 wherein the conveyor moves the agglomerated potato product in said first direction at a speed of about 0.5 feet per second, and further wherein said; the roller has a diametric size of about 1.5 inch and is driven in the same direction at a rotational speed of about 1,000-1,100 revolutions per minute.

31. The system of claim 30 wherein the roller is spaced above the conveyor by about 3/32 inch.

32. The system of claim 22 wherein the dryer comprises a fluidized bed dryer with an air temperature within the range of from about 110° F. to about 285° F.

33. The process of claim 32 wherein the fluidized bed dryer has an air temperature within the range of from about 140° F. to about 180° F.

34. A system for preparing an agglomerated potato product, said system comprising:
a pre-blender for pre-blending dry and wet flavor ingredients including salt, powdered milk, butter flavors, lactic acid, sodium stearoyl lactylate, a coloring agent, water, or oil, or mixtures thereof;
a mixer for mixing the pre-blended dry and wet flavor ingredients with potato product including potato flakes or potato granules, or mixtures thereof, dried to a moisture level of about 6-8% to form a mixed product;
a conveyor for receiving the mixed product and for conveying the mixed product in a first direction;
a roller spaced closely overhead relative to the conveyor, said roller being driven at a speed greater than the conveyor speed to form the mixed product into a relatively thin mixed product layer on the conveyor; and
a dryer for receiving the relatively thin mixed product layer from the conveyor for reducing the moisture level thereof to about 6-8% to produce the agglomerated potato product in substantially granular form.

35. The system of claim 34 wherein water comprises at least one of the wet flavor ingredients, said water being at a temperature of about 40° F. to about 160° F.

36. The system of claim 34 wherein oil comprises at least one of the wet flavor ingredients, said oil comprising a soy oil.

37. The system of claim 34 further comprising an auger for delivering the mixed product from the mixer onto the conveyor.

38. The system of claim 34 wherein the conveyor moves the mixed product at about 0.5 feet per second, and the roller has a diametric size of about 1.5 inch and is driven in the same direction at a rotational speed of about 1,000-1,100 revolutions per minute.

39. The system of claim 38 wherein the roller is spaced above the conveyor by about 3/32 inch.

40. The system of claim 34 wherein the dryer comprises a fluidized bed dryer with an air temperature within the range of from about 110° F. to about 285° F.

41. The process of claim 40 wherein the fluidized bed dryer has an air temperature within the range of from about 140° F. to about 180° F.
